(19) United States
(12) Patent Application Publication
(10) Pub. No.: US 2022/0092634 A1
(43) Pub. Date: Mar. 24, 2022

(54) INFORMATION PROCESSING DEVICE AND NON-TRANSITORY COMPUTER READABLE MEDIUM

(71) Applicant: FUJIFILM Business Innovation Corp., Tokyo (JP)

(72) Inventor: Shotaro MISAWA, Kanagawa (JP)

(73) Assignee: FUJIFILM Business Innovation Corp., Tokyo (JP)

(21) Appl. No.: 17/180,664

(22) Filed: Feb. 19, 2021

(30) Foreign Application Priority Data
Sep. 23, 2020 (JP) 2020-159117

(51) Int. Cl. G06Q 30/02; G06N 20/00

(52) U.S. Cl. CPC G06Q 30/0242; G06Q 30/0255; G06N 20/00

(57) ABSTRACT

An information processing device includes a processor configured to acquire subject information and classification information, the subject information being information related to a subject to advertise, and the classification information being information classifying advertising copy related to the subject into a set, and estimate a user reaction by inputting the acquired subject information and classification information into a trained reaction estimation model that estimates the user reaction.

### CROSS-REFERENCE TO RELATED APPLICATIONS

This application is based on and claims priority under 35 USC 119 from Japanese Patent Application No. 2020-159117 filed Sep. 23, 2020.

### BACKGROUND

### (i) Technical Field

The present disclosure relates to an information processing device and a non-transitory computer readable medium.

### (ii) Related Art

Japanese Unexamined Patent Application Publication No. 2007-164483 discloses an advertisement text generation device provided with a means for acquiring a metaphor as a word associated with a brand image or a product concept expressed in words, a means for acquiring a sentence pattern that most appeals to consumers for expressing the brand image or product concept as a sentence, and a means for generating advertisement text from the acquired metaphor and the sentence pattern.

Advertising copy (also referred to as a slogan or catchphrase) is created for a specific demographic to which a product is planned to be sold. Furthermore, advertising copy has an effect of engaging user interest, and therefore also influences the sales volume of the product. For these reasons, there exists a technology that detects a user reaction to advertising copy in the past (such as the sales volume, number of clicks, and number of views, for example), and stores advertising copy in association with the detected user reaction.

### SUMMARY

Aspects of non-limiting embodiments of the present disclosure relate to estimating a user reaction to advertising copy in a case where the advertising copy is attached to a subject to advertise.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to acquire subject information and classification information, the subject information being information related to a subject to advertise, and the classification information being information classifying advertising copy related to the subject into a set, and estimate a user reaction by inputting the acquired subject information and classification information into a trained reaction estimation model that estimates the user reaction.

### BRIEF DESCRIPTION OF THE DRAWINGS

An exemplary embodiment of the present disclosure will be described in detail based on the following figures, wherein:

FIG. 1 is a configuration diagram illustrating an example of a hardware configuration of an information processing device according to an exemplary embodiment;

FIG. 2 is a block diagram illustrating an example of a functional configuration of an information processing device according to the exemplary embodiment;

FIG. 3 is a diagram illustrating an example of a collected information database according to the exemplary embodiment;

FIG. 4 is a data-flow diagram illustrating an example of the flow of processes during a training process according to the exemplary embodiment;

FIG. 5 is a schematic diagram illustrating an example of a neural network according to the exemplary embodiment;

FIG. 6 is a schematic diagram illustrating an example of an encoder-decoder model comprising a recurrent neural network according to the exemplary embodiment;

FIG. 7 is a data-flow diagram illustrating an example of the flow of processes during an estimation process according to the exemplary embodiment;

FIG. 8 is a flowchart illustrating an example of the flow of information processing during the training process according to the exemplary embodiment;

FIG. 9 is a flowchart illustrating an example of the flow of information processing during the estimation process according to the exemplary embodiment; and

FIG. 10 is a schematic diagram illustrating an example of an encoder-decoder model comprising a recurrent neural network according to an exemplary modification of the exemplary embodiment.

### DETAILED DESCRIPTION

Hereinafter, an exemplary embodiment for carrying out the present disclosure will be described in detail and with reference to the drawings.

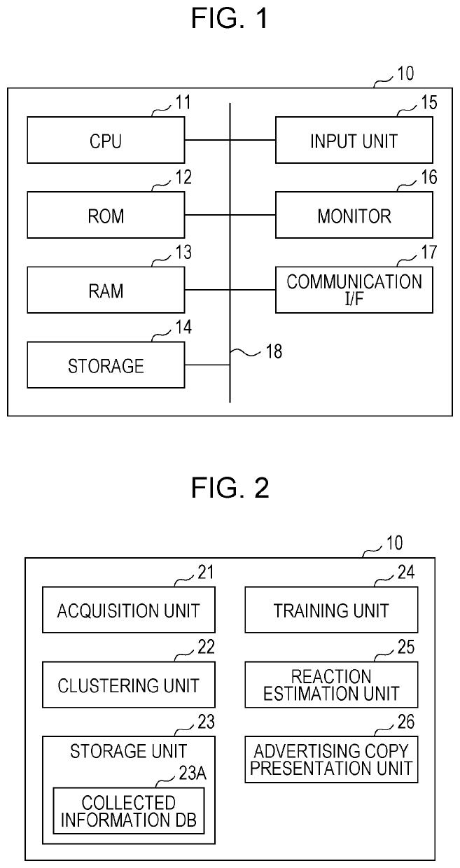

FIG. 1 will be referenced to describe the configuration of the information processing device 10. FIG. 1 is a block diagram illustrating an example of a hardware configuration of the information processing device 10 according to the exemplary embodiment. As an example, the information processing device 10 according to the exemplary embodiment is a terminal such as a personal computer, or is a server.

As illustrated in FIG. 1, the information processing device 10 according to the exemplary embodiment includes a central processing unit (CPU) 11, read-only memory (ROM) 12, random access memory (RAM) 13, storage 14, an input unit 15, a monitor 16, and a communication interface (communication I/F) 17. The CPU 11, the RAM 12, the ROM 13, the storage 14, the input unit 15, the monitor 16, and the communication I/F 17 are interconnected by a bus 18. Here, the CPU 11 is an example of a processor.

The CPU 11 centrally controls the information processing device 10 overall. The RAM 12 stores various programs, including an information processing program used in the exemplary embodiment, data, and the like. The ROM 13 is memory used as a work area when executing the various programs. The CPU 11 performs a process of estimating information such as a sales amount by loading a program stored in the RAM 12 into the ROM 13 and executing the program. The storage 14 is a component such as a hard disk drive (HDD), a solid-state drive (SSD), or flash memory, for example. Note that the information processing program and the like may also be stored in the storage 14. The input unit 15 includes devices such as a mouse and keyboard that receive text input and the like. The monitor 16 displays information such as text and images. The communication I/F 17 transmits and receives data.

Next, FIG. 2 will be referenced to describe a functional configuration of the information processing device 10. FIG. 2 is a block diagram illustrating an example of a functional configuration of the information processing device 10 according to the exemplary embodiment.

As illustrated in FIG. 2, the information processing device 10 is provided with an acquisition unit 21, a clustering unit 22, a storage unit 23, a training unit 24, a reaction estimation unit 25, and an advertising copy presentation unit 26. The CPU 11 executes the information processing program and thereby functions as the acquisition unit 21, the clustering unit 22, the storage unit 23, the training unit 24, the reaction estimation unit 25, and the advertising copy presentation unit 26. Here, the reaction estimation unit 25 is an example of a reaction estimation model, and the advertising copy presentation unit 26 is an example of an advertising copy presentation model.

The acquisition unit 21 acquires input information input by a user. Specifically, the acquisition unit 21 acquires information related to a product (hereinafter referred to as “product information”). Product information refers to information that includes information identifying a product (for example, a product identification (ID)), the name of the product, slogans for the product, a sales amount for each slogan, and the like. Here, the product is an example of a subject, and the product information is an example of subject information. Note that, as an example, the exemplary embodiment describes a configuration in which a “product” is the subject to which a slogan is assigned. However, the subject is not limited thereto. The subject to which a slogan is assigned may also be an advertisement, a news article, or a website, for example.

Also, in the training process, the acquisition unit 21 acquires product information such as a product ID input by the user, and cluster information described later.

Note that a configuration is described in which the product information according to the exemplary embodiment includes an ID that identifies a product, the name of the product, slogans for the product, and a sales amount for each slogan. However, the product information is not limited thereto. The product information may also include descriptive text related to the product, information related to components or ingredients contained in the product, information that identifies a buyer of the product, a time period during which a slogan related to the product is posted, and a target demographic at which the slogan is aimed.

The clustering unit 22 clusters acquired slogans for a product and derives information (hereinafter referred to as “cluster information”) about a cluster to which the slogans belong. As an example, in the exemplary embodiment, slogans are classified using k-means clustering, which is a type of non-hierarchical clustering. With k-means clustering, k pieces of data that act as representative points are selected from the entire data, the distance between each of the representative points and the other data excluding the representative points is derived, and the data is classified into clusters according to the derived distances. Also, with k-means clustering, a center of mass of the data classified into each cluster is derived, and the centroid is re-set as the representative point of the cluster. Note that the exemplary embodiment describes a configuration in which k-means clustering is used to perform classification. However, the configuration is not limited thereto. For example, the group average method may be used, or Ward's method may be used. Also, the exemplary embodiment describes a technique of using a clustering method to classify slogans for a product. However, the configuration is not limited thereto. Information may also be classified by the user. For example, labels indicating types of slogans may be selected by the user, and slogans may be classified into each selected label. Here, a cluster is an example of a “set”, and cluster information is an example of “classification information”.

The storage unit 23 stores the product information and the cluster information in association with each slogan as information that has been collected (hereinafter referred to as “collected information”). The storage unit 23 stores the collected information in a collected information database (hereinafter referred to as the “collected information DB”) 23A.

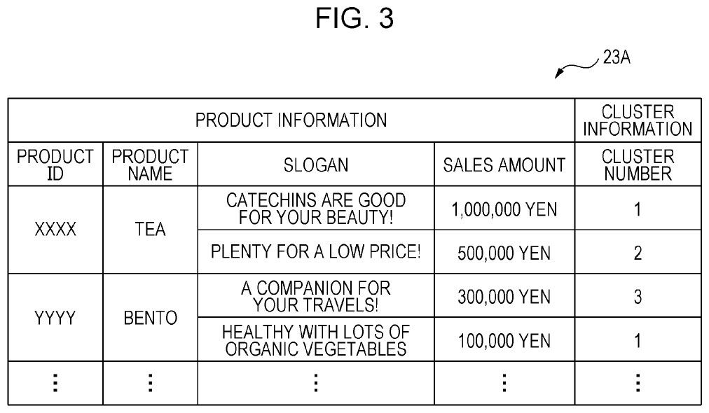

As an example, as illustrated in FIG. 3, the collected information DB 23A includes product information and cluster information. The product information includes a product ID, a product name, slogans for each product, and a sales amount for each slogan. The product ID is one or more characters for identifying the product, while the product name is the name of the product. Each slogan is text assigned to advertise the product, and each sales amount is the total sales of the product for each slogan.

Also, the cluster information includes a cluster number. The cluster number is a number for identifying a cluster, and is stored in association with each slogan to indicate the type of cluster to which the slogan belongs. Note that a configuration is described in which the cluster information according to the exemplary embodiment is a cluster number that indicates the type of cluster. However, the configuration is not limited thereto. The cluster information may be any kind of information that identifies a cluster. A word (attribute) indicating a property or feature of a cluster may also be extracted from slogans, and the word may be stored as the cluster information. For example, words included in slogans may be extracted, such as “Health” for a cluster 1, “Low-price” for a cluster 2, and “Travel” for a cluster 3, and each word indicating a property or feature of each cluster may be treated as the cluster information.

The training unit 24 uses the collected it formation stored in the collected information DB 23A as training data to train the reaction estimation unit 25. Specifically the training unit 24 trains the reaction estimation unit 25 by using the product information and the cluster information as the input data, and. using the sales amounts as the output data. Also, the training unit 24 trains the advertising copy presentation unit 26 by using the product information and the cluster information as the input data, and using the slogans as the output data.

The reaction estimation unit 25 uses the product information and the cluster information to estimate a sales amount (hereinafter referred to as a “sales estimate”) and the likelihood (hereinafter referred to as the confidence level) of the sales estimate according to the product information and the cluster information. Specifically, the reaction estimation unit 25 uses the product ID and the cluster number to estimate the sales estimate of the product corresponding to the cluster as well as the confidence level of the sales estimate. Note that the exemplary embodiment describes a configuration in which the product ID is used as the product information. However, the configuration is not limited thereto. The information may be any information included in the product information, such as the description of the product or a slogan, and furthermore, multiple types of information included in the product information may be combined.

The advertising copy presentation unit 26 uses the product information and the cluster information to present slogans for the product information and the cluster information. Specifically, the advertising copy presentation unit 26 presents slogans in relation to the product ID and the cluster number. Here, the advertising copy presentation unit 26 is an example of an advertising copy presentation model. Also, in the following, a slogan presented by the advertising copy presentation unit 26 is referred to as “advertising copy”, while a slogan stored in the collected information DB 23A is referred to as a “slogan”.

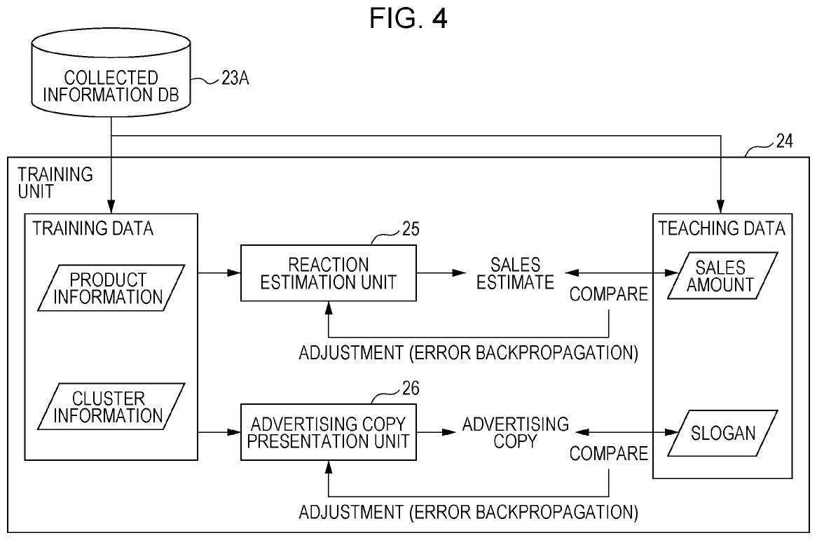

Next, before describing the action of the information processing device 10, FIGS. 4 to 7 will be referenced to describe a method of estimating a reaction and presenting advertising copy according to the exemplary embodiment. FIG. 4 is a data-flow diagram illustrating an example of the flow of processes in an explanation of the training process according to the exemplary embodiment.

As an example, as illustrated in FIG. 4, in the process of training the reaction estimation unit 25 and the advertising copy presentation unit 26, the training unit 24 performs training by using the collected information stored in the collected information DB 23A as training data.

The training unit 24 performs batch training on the reaction estimation unit 25 using the product information and the cluster information acquired from the collected information DB 23A as training data and the sales amounts acquired from the collected information DB 23A as teaching data. The reaction estimation unit 25 estimates the sales estimate from the training data containing the product information and the cluster information, and also estimates the confidence level of the sales estimate.

The reaction estimation unit 25 estimates a user reaction. The user reaction is a value such as a sales amount, a sales volume, a number of clicks, or a number of views, for example. The exemplary embodiment describes a configuration in which the reaction estimation unit 25 estimates the sales amount (sales estimate) as the user reaction. However, the configuration is not limited thereto. A value such as a sales volume, a number of clicks, or a number of views may also be estimated as the user reaction.

Also, the reaction estimation unit 25 uses the input product information and cluster information as training data to estimate the sales estimate. For example, the reaction estimation unit 25 estimates the sales estimate with respect to the product information and the cluster information by using statistical regression analysis. In addition, the reaction estimation unit 25 trains by comparing the sales amount provided as teaching data to the estimated sales amount.

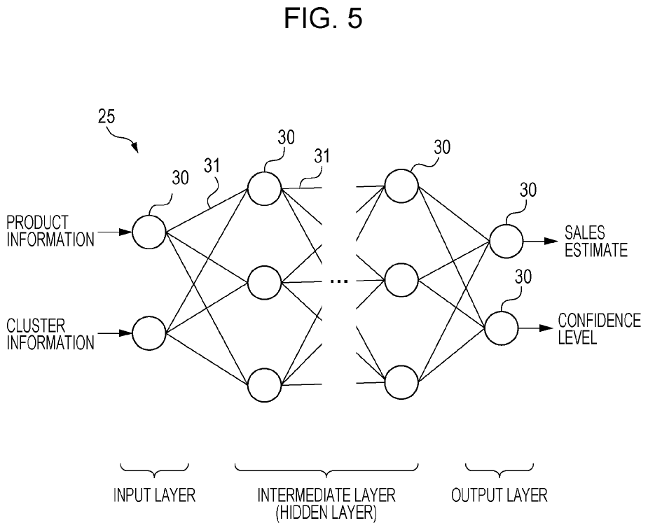

Here, the reaction estimation unit 25 and the advertising copy presentation unit 26 are machine learning models using a neural network. As illustrated in FIG. 5 as an example, the neural network has multiple layers of nodes 30 that perform processing in an input layer, intermediate layer (hidden layers), and an output layer. The nodes 30 in each layer are joined by edges 31, and the neural network performs processing by propagating data processed by each of the nodes 30 in order from the input layer, through the intermediate layers, to the output layer.

Additionally, the reaction estimation unit 25 is also capable of deriving multiple sales estimates and a corresponding confidence level for each. Consequently, in the case of deriving multiple sales estimates and a corresponding confidence level for each piece of product information and cluster information, the reaction estimation unit 25 may output the sales estimate having the highest confidence level as the sales estimate estimated by the reaction estimation unit 25.

Also, the reaction estimation unit 25 uses error backpropagation to adjust each layer. Error backpropagation refers to a technique of deriving a loss function that computes the error between the output of the machine learning model and teaching data, and updating weight parameters for the edges 31 that join each of the nodes 30 so as to minimize the value of the loss function.

For example, as illustrated in FIG. 5, the neural network performs processing by multiplying the weight parameters of the edges 31 by a value derived by each of the nodes 30, and passing the result to the next layer as input. In other words, because the output of any layer depends on the value output by the nodes 30 in the preceding layer and the weight parameters of the joining edges 31, the output of any layer is adjustable by updating the weight parameters for the edges 31 that join with the nodes 30 in the preceding layer. That is, error backpropagation is a technique of updating the weight parameters in the direction from the output to the input (in order from the output layer, through the intermediate layers, to the input layer) to adjust the output.

A loss function of the related art is derived using the square error obtained by squaring the difference between the sales estimate and the sales amount in the teaching data. A loss function according to the exemplary embodiment is expressed by the following expression that accounts for the confidence level.

$$L = \frac{{λ}_{1}}{N} {( E - R )}^{2} \times C + \frac{{λ}_{2}}{C} \qquad ( 1 )$$

Here, L is the magnitude of the error derived by the loss function, while λ₁ and λ₂ are balance coefficients of the loss functions. Also, N is the number of data points, E is the estimated sales estimate, R is the sales amount in the teaching data, and C is the confidence level corresponding to the sales estimate.

As in the above expression, the square of the difference between the sales estimate estimated by the reaction estimation unit 25 and the sales amount in the teaching data is multiplied by the confidence level to derive an error accounting for the confidence level, and the reciprocal of the confidence level is added to the derived error to derive the error magnitude L. With error backpropagation, the weight parameters are updated by the reaction estimation unit 25 so as to minimize the derived error magnitude L. Note that in the exemplary embodiment, the confidence level is used to derive the error magnitude. For example, in the first term of Expression (1) above, the square of the difference between the sales estimate and the sales amount is multiplied by the confidence level to derive the error magnitude, and therefore the weight parameters are updated so as to decrease the square of the difference between the sales estimate and the sales amount as well as the confidence level. In other words, in the first term of Expression (1) above, the weight parameters are updated such that the confidence level becomes smaller, irrespectively of the magnitude of the confidence level. Also, in the second term of Expression (1) above, by adding the reciprocal of the confidence level, the weight parameters are updated such that the second term of Expression (1) above becomes smaller (the confidence level becomes larger). Consequently, in Expression (1) above, the weight parameters are updated so as to lower the confidence level in the first term while the weight parameters are updated so as to raise the confidence level in the second term. For this reason, the confidence level in the case where Expression (1) above is minimized is the confidence level corresponding to the sales estimate.

Also, the loss function in the exemplary embodiment is described as being the value obtained by squaring the difference between the estimated sales estimate and the sales amount in the teaching data. However, the configuration is not limited thereto. In the case of training by using a large amount of data like in batch training, the mean squared error obtained by averaging the square of the difference between the sales estimate in each piece of training data and the sales amount in the teaching data may also be used as the loss function.

Next, the method by which the training unit 24 trains the advertising copy presentation unit 26 will be described. As illustrated in FIG. 4, the training unit 24 performs batch training on the advertising copy presentation unit 26 using the product information and the cluster information acquired from the collected information DB 23A as training data and the slogans acquired from the collected information DB 23A as teaching data. The advertising copy presentation unit 26 outputs advertising copy estimated from the training data containing the product information and the cluster information.

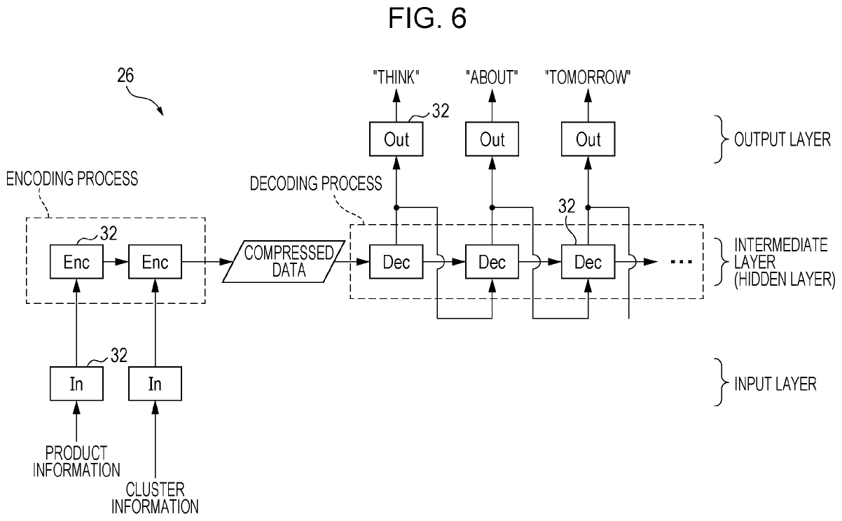

For example, as illustrated in FIG. 6, the advertising copy presentation unit 26 is an encoder-decoder model comprising a recurrent neural network. A recurrent neural network is used as a machine learning model for learning natural language, and in an intermediate layer, processed data is propagated to different nodes 32 in the same layer for processing. Also, an encoder-decoder model is a model that performs, in an intermediate layer, an encoding process that extracts and compresses features from input training data into a vector of predetermined order and a decoding process that decodes words from the features included in the compressed data. Advertising copy is estimated by inputting product information and cluster information into the advertising copy presentation unit 26 configured as an encoder-decoder model comprising a recurrent neural network.

The advertising copy presentation unit 26 is provided with dictionary data storing multiple predetermined words, and derives the likelihood of a word stored in the dictionary data by using compressed data obtained by compressing features of the input product information and cluster information as well as the immediately preceding output words. The advertising copy presentation unit 26 selects the word having the highest likelihood as the word to output next. The advertising copy presentation unit 26 repeats the above process of selecting a word until a word indicating the end of the advertising copy (such as a punctuation mark or a terminating character string, for example) is selected.

Note that a configuration is described in which the advertising copy presentation unit 26 according to the exemplary embodiment generates advertising copy by generating words from the input product information and cluster information. However, the configuration is not limited thereto. Advertising copy may also be selected and presented from among advertising copy created in advance, or advertising copy may be generated and presenting by selecting an advertising copy template and words to apply to the template.

For example, the advertising copy presentation unit 26 learns advertising copy in advance by using product information and cluster information as training data. The advertising copy presentation unit 26 uses compressed data obtained by compressing features of the input product information and cluster information to derive the likelihood of advertising copy created and stored in advance. The advertising copy presentation unit 26 may also select and present the advertising copy having the highest likelihood as the estimated advertising copy.

Additionally, the advertising copy presentation unit 26 derives the likelihood from the input product information and cluster information, and selects an advertising copy template according to the likelihood. The advertising copy presentation unit 26 may also use the product information, the cluster information, and the template to derive the likelihood from dictionary data, select words having the highest likelihood as the words to apply to the template, and present advertising copy.

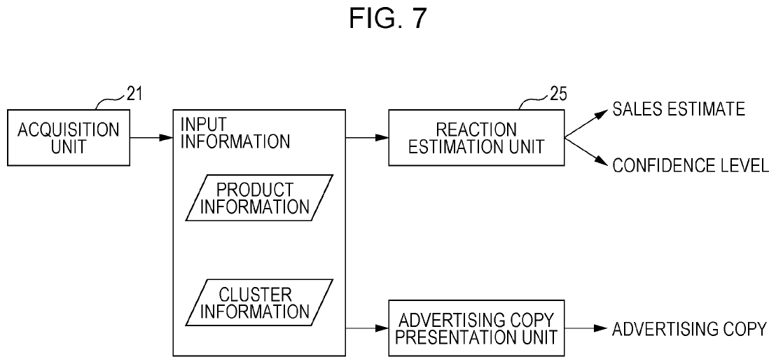

Next, FIG. 7 will be referenced to describe a technique of estimating the sales estimate and presenting advertising copy according to the exemplary embodiment. FIG. 7 is a data-flow diagram illustrating an example of the flow of processes during an estimation process according to the exemplary embodiment.

For example, as illustrated in FIG. 7, the acquisition unit 21 acquires product information and cluster information input by the user, and the reaction estimation unit 25 uses the acquired product information and cluster information as input information to estimate the sales estimate and the confidence level.

Here, the information processing device 10 according to the exemplary embodiment inputs one piece of product information and multiple pieces of cluster information into the reaction estimation unit 25 to thereby estimate the sales estimate and the confidence level for each combination of the product information and the cluster information. Additionally, the information processing device 10 uses the estimated sales estimate and confidence level to specify and select a combination of product information and cluster information. For example, in the case where the estimated sales estimate and confidence level are each greater than a predetermined threshold (such as a sales estimate of 1 billion yen and a confidence level of 0.8, for example), the product information and the cluster information associated with the sales estimate and the confidence level are specified.

Note that in the estimation process of the exemplary embodiment, a combination of the product information and the cluster information that is not stored in the collected information DB 23A is selected. For example, in the case where the combination of the product ID “XXXX” and the cluster number “3” is not stored in the collected information DB 23A, the combination of the product ID “XXXX” and the cluster number “3” is selected. By selecting a combination not stored in the collected information DB 23A, the sales estimate, confidence level, and advertising copy for a combination of a product and a type of slogan that does not have a record of sales performance is obtained. Here, a configuration is described in which the selected combination of the product information and the cluster information according to the exemplary embodiment is a combination that is not stored in the collected information DB 23A. However, the configuration is not limited thereto. A combination of product information and cluster information having less stored data compared to other combinations (such as an amount of data that is half the average or less, for example) may also be selected. Additionally, a combination of product information and cluster information having a predetermined amount of data or less may be selected, or a combination of product information and cluster information that does not have a record of sales performance within a predetermined period may be selected.

Also, in the exemplary embodiment, a configuration is described in which the threshold values for the estimated sales estimate and confidence level are predetermined. However, the configuration is not limited thereto. A range having upper and lower bounds set may also be predetermined for each of the estimated sales estimate and confidence level.

For example, in the case where the estimated sales estimate and confidence level exceed the upper bound of each predetermined range, the reaction estimation unit 25 may specify the product information and cluster information associated with the estimated sales estimate and confidence level.

Also, in the case where the estimated sales estimate and confidence level do not exceed the upper bound of each predetermined range, the reaction estimation unit 25 determines whether the estimated confidence level falls below the lower bound of the predetermined range. In the case of determining that the estimated confidence level falls below the lower bound of the predetermined range, the reaction estimation unit 25 may specify the product information and cluster information associated with the estimated confidence level. Here, the product information and cluster information associated with a confidence level that is lower than the predetermined range have a low probability of reaching the estimated sales amount. In other words, it is anticipated that a low confidence level will overturn expectations and reach a higher sales amount than the estimated sales estimate.

Also, the exemplary embodiment describes a configuration that specifies the product information and cluster information associated with the sales estimate and the confidence level in the case where the sales estimate and the confidence level exceed or fall below a predetermined threshold value for each. However, the configuration is not limited thereto. Estimated sales estimates or confidence levels may also be compared, and the one having a larger user reaction, such as the one having the largest sales estimate or confidence level from among the sales estimates or confidence levels may be specified with priority, and the product information and cluster information associated with the largest sales estimate or confidence level may be specified, for example. Additionally, a priority order in order of the largest estimated sales estimates or confidence levels may be set, and the sales estimate or confidence level at a predetermined place in the priority order may be specified as the one having the largest user reaction, and the product information and cluster information associated with the specified sales estimate or confidence level may be specified. Conversely, the pair having a low confidence level from among pairs of multiple user reactions and multiple corresponding confidence levels may also be specified with priority.

Also, the exemplary embodiment describes a configuration in which the sales estimate and the confidence level are compared to a predetermined threshold value for each. However, the configuration is not limited thereto. The sales estimate and the confidence level may also be multiplied to derive an expected value of the sales amount, and the expected value of the sales amount may be compared to a predetermined threshold value.

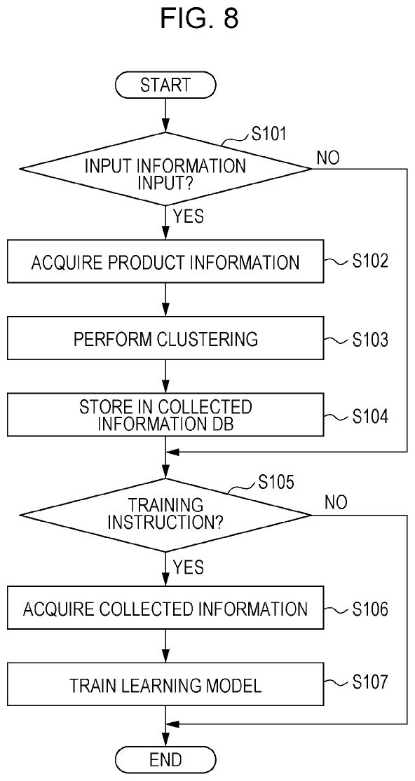

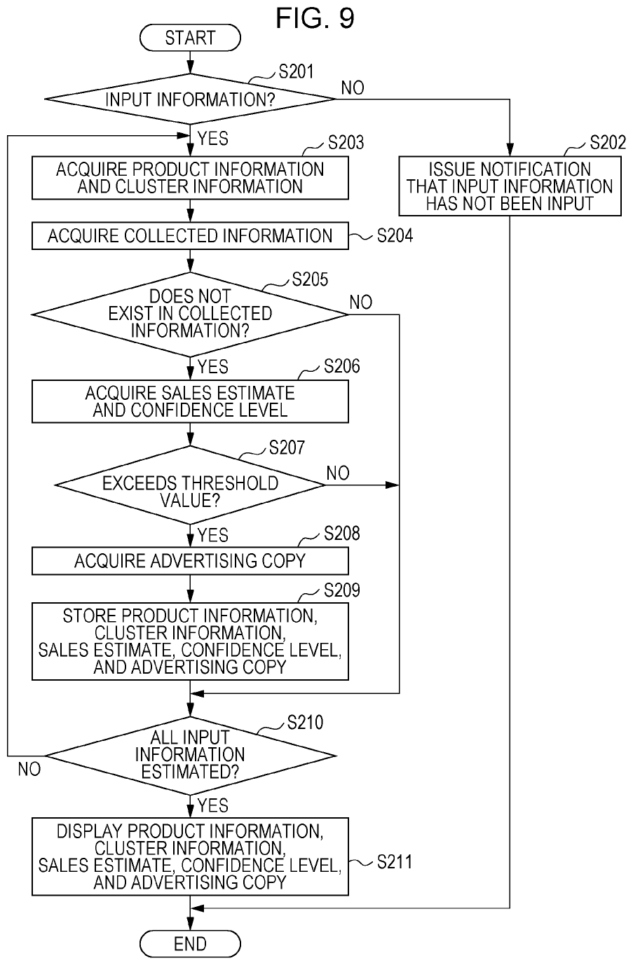

Next, FIGS. 8 and 9 will be referenced to describe the action of the information processing device 10 according to the exemplary embodiment. FIG. 8 is a flowchart illustrating an example of a training process according to the exemplary embodiment. The training program illustrated in FIG. 8 is executed by causing the CPU 11 to read out and execute a training program from the RAM 12 or the storage 14. The training program illustrated in FIG. 8 is executed in the case where at least one of input information including product information and a training instruction is input by the user, for example.

In step S101, the CPU 11 determines whether or not input information is input by the user. In the case where input information is input by the user (step S101: YES), the CPU 11 proceeds to step S102. On the other hand, in the case where input information is not input by the user (step S101: NO), the CPU 11 proceeds to step S105.

In step S102, the CPU 11 acquires product information including slogans from the input information.

In step S103, the CPU 11 acquires slogans from the acquired product information, and clusters the slogans to acquire cluster information associated with the product information.

In step S104, the CPU 11 stores the product information and the cluster information in the collected information DB 23A.

In step S105, the CPU 11 determines whether or not a training instruction is input by the user. In the case where a training instruction is input (step S105: YES), the CPU 11 proceeds to step S106. On the other hand, in the case where a training instruction is not input (step S105: NO), the CPU 11 ends the training process.

In step S106, the CPU 11 acquires collected information, including product information, cluster information, slogans, and sales amounts, from the collected information DB 23A.

In step S107, the CPU 11 uses the product information, cluster information, slogans, and sales amounts to train the reaction estimation unit 25 and the advertising copy presentation unit 26. Here, the CPU 11 trains the reaction estimation unit 25 by treating the product information and the cluster information from the collected information DB 23A as training data and treating the sales amounts acquired from the collected information DB 23A as teaching data. Also, the CPU 11 trains the advertising copy presentation unit 26 by treating the product information and the cluster information from the collected information DB 23A as training data and treating the slogans acquired from the collected information DB 23A as teaching data.

Next, FIG. 9 will be referenced to describe the action of an estimation process according to the exemplary embodiment. FIG. 9 is a flowchart illustrating an example of an estimation process according to the exemplary embodiment. The estimation program illustrated in FIG. 9 is executed by causing the CPU 11 to read out and execute an estimation program from the RAM 12 or the storage 14. The estimation program illustrated in FIG. 9 is executed in the case where input information including product information and cluster information is input by the user, and an instruction to estimate the sales estimate, confidence level, and advertising copy is input by the user, for example.

In step S201, the CPU 11 determines whether or not input information is input by the user. In the case where input information is input by the user (step S201: YES), the CPU 11 proceeds to step S203. On the other hand, in the case where input information is not input by the user (step S201: NO), the CPU 11 proceeds to step S202.

In step S202, the CPU 11 notifies the user that input information has not been input, and ends the series of processes.

In step S203, the CPU 11 acquires product information and cluster information from the input information.

In step S204, the CPU 11 acquires collected information from the collected information DB 23A.

In step S205, the CPU 11 determines whether the combination of the acquired product information and cluster information does not exist in the collected information. In the case where the combination of the acquired product information and cluster information does not exist in the collected information (step S205: YES), the CPU 11 proceeds to step S206. On the other hand, in the case where the combination of the acquired product information and cluster information exists in the collected information (step S205: NO), the CPU 11 proceeds to step S210.

In step S206, the CPU 11 uses the product information and cluster information to acquire the estimated sales estimate and confidence level.

In step S207, the CPU 11 determines whether or not the estimated sales estimate and confidence level each exceed a predetermined threshold value. In the case where the estimated sales estimate and confidence level each exceed the predetermined threshold value (step S207: YES), the CPU 11 proceeds to step S208. On the other hand, in the case where the estimated sales estimate and confidence level each do not exceed the predetermined threshold value (step S207: NO), the CPU 11 proceeds to step S210.

In step S208, the CPU 11 uses the product information and the cluster information to acquire presented advertising copy.

In step S209, the CPU 11 stores the sales estimate, the confidence level, and the advertising copy in association with the product information and the cluster information.

In step S210, the CPU 11 determines whether or not the estimation process has been performed on all of the input information. In the case where the estimation process has been performed on all of the input information (step S210: YES), the CPU 11 proceeds to step S211. On the other hand, in the case where the estimation process has not been performed on all of the input information (that is, in the case where unprocessed input information exists) (step S210: NO), the CPU 11 proceeds to step S203.

In step S211, the CPU 11 displays the stored product information, cluster information, sales estimate, confidence level, and advertising copy.

As described above, according to the exemplary embodiment, by inputting cluster information different from the cluster information associated with a slogan assigned to the product information in the past, the sales estimate is estimated for a combination of product information and cluster information that does not have a record of sales performance. Consequently, in the case of assigning a different type of advertising copy to a product compared to the type of advertising copy used in the past, the sales estimate for the different type of advertising copy is estimated as one example of the user reaction.

### (Exemplary Modifications)

Note that in the exemplary embodiment described above, a configuration that uses a loss function to estimate the confidence level corresponding to the sales estimate is described. However, the configuration is not limited thereto. The confidence level with respect to sales estimate estimated from the product information and the cluster information may also be estimated. As an example, the reaction estimation unit 25 is capable of using logistic regression analysis to estimate the confidence level with respect to the sales estimate. For example, collected information is used to find the total sales amounts for each piece of product information and each piece of cluster information, and by defining the confidence level with respect to the sales amount from the amounts of data in the product information and the cluster information, a logistic function that derives the confidence level is derived. Specifically, periods of purchasing by users are derived for each product ID and each cluster number from the collected information, and the confidence level corresponding to a period is defined such that the confidence level rises proportionally with periods of higher purchasing. With this arrangement, the confidence level with respect to the sales amount is derived from the collected information, and the confidence level with respect to an estimated sales amount is estimated by logistic regression analysis. Here, the exemplary embodiment describes a configuration that defines the confidence level for each product ID and each cluster number. However, the configuration is not limited thereto. The confidence level may also be defined with consideration for factors such as products classified into the same category or similar products. For example, collaborative filtering may be used to define a confidence level that accounts for similar products. Collaborative filtering compares the buyers of multiple products with each other, and defines a similarity such that the similarity rises for products that have more overlapping buyers. By using collaborative filtering, the confidence level may be derived, or the derivation of the confidence level may be assisted, on the basis of the sales of similar products.

Also, a configuration is described in which the confidence level according to the above exemplary embodiment is derived according to the amount of data for each piece of product information and each piece of cluster information. However, the configuration is not limited thereto. An formula for deriving the confidence level may also be predefined, and the classified results may be used to derive the confidence level for each piece of product information and each piece of cluster information. For example, a confidence level using the classified results is expressed by the following expression.

C_{R}=MS+SI−VA−SS (2)

In the above expression, CR is the confidence level with respect to the sales amount, MS is the number of slogans positioned a predetermined distance from the clustered slogans, and SI is the confidence level of a product highly similar to the products associated with the classified slogans. Also, VA is the degree of variation in the sales amounts for each condition (such as the period during which the slogan is displayed and the target demographic at which the slogan is aimed) of the products associated with the classified slogans, and SS is the distance to the nearest slogan to the classified slogans.

Also, a configuration is described in which the reaction estimation unit 25 according to the above exemplary embodiment estimates each of the sales estimate and the confidence level one at a time. However, the configuration is not limited thereto. The reaction estimation unit 25 may also estimate multiple sales estimates and confidence levels, or estimate classes of sales estimates classified by predetermined ranges and estimate a confidence level for each class.

For example, in the case of estimating multiple sales estimates, the reaction estimation unit 25 may estimate a continuous range of sales estimates (such as from 100 million yen to 500 million yen, for example), or may estimate discrete sales estimates.

Also, in the case of estimating continuous sales estimates, or in the case of estimating ranges or classes of sales estimates, an expression like the following is used to adjust the weight parameters of the loss function in the error backpropagation.

L=λ₃(Eₘₐₓ−Eₘᵢₙ)+λ₄MAX(R−Eₘₐₓ, 0)+λ₅MAX(Eₘᵢₙ−R, 0) (3)

Here, λ₃, λ₄, and λ₅ are balance coefficients of the loss function. Eₘₐₓ is the maximum value of the estimated sales estimates, while Eₘᵢₙ is the minimum value of the estimated sales estimates. Also, MAX is a function that returns the largest of the given arguments as the return value.

For example, MAX (R−Eₘₐₓ, 0) returns R−Eₘₐₓ in the case where R−Eₘₐₓ is greater than 0, and returns 0 in the case where R−Eₘₐₓ is less than 0. In the case where the maximum value Eₘₐₓ of the estimated sales estimates is larger than the sales amount R of the teaching data, the sales amount R of the teaching data is contained in the range estimated by the reaction estimation unit 25, and the sales are being estimated correctly. Consequently, the training unit 24 returns 0 as the return value, and does not influence the loss function. On the other hand, in the case where the maximum value Eₘₐₓ of the estimated sales estimates is smaller than the sales amount R of the teaching data, the sales amount R is not contained in the range estimated by the reaction estimation unit 25, and the reaction estimation unit 25 is not estimating the sales correctly. For this reason, the training unit 24 returns the difference between the sales amount R of the teaching data and the maximum value Eₘₐₓ of the estimated sales estimates as the return value, and adds the return value to the loss function. Consequently, by using the above expression, whether or not the sales amount R of the teaching data is contained in the range of the estimated sales estimates is accounted for, and error backpropagation is used to adjust the weight parameters.

Also, a configuration is described in which the advertising copy presentation unit 26 according to the above exemplary embodiment uses the product information and the cluster information to present advertising copy. However, the configuration is not limited thereto. For example, a character string may be input together with the product information and the cluster information, and advertising copy may be presented according to the character string.

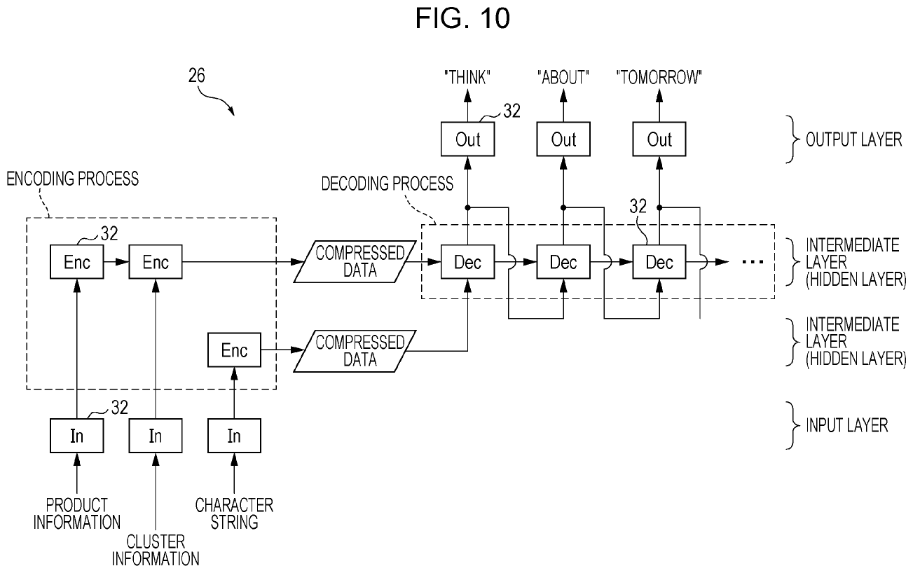

For example, as illustrated in FIG. 10, the advertising copy presentation unit 26 is a recurrent neural network. The advertising copy presentation unit 26 performs a decoding process using compressed data in which features have been compressed by performing an encoding process on product information and cluster information, and compressed data in which features have been compressed by performing an encoding process on a character string.

The advertising copy presentation unit 26 uses the compressed data in which the features of the product information and the cluster information are compressed and the compressed data in which the features of the character string are compressed to derive the likelihood of words stored in dictionary data, and selects the character string having the highest likelihood as the next word to output. Also, the advertising copy presentation unit 26 inputs the output word into the next node 32 to select the next word to output. In other words, by inputting a character string into the advertising copy presentation unit 26, the character string is treated as a start point, and by complementing the character string with subsequent words, advertising copy is completed and presented. By this process, advertising copy reflecting the user's desires is presented.

Additionally, the advertising copy presentation unit 26 according to an exemplary modification of the exemplary embodiment is capable of selecting and displaying multiple words to follow the character string, and thereby present advertising copy desired by the user. For example, multiple words to output next after the input character string are selected and displayed, the user selects one of the multiple displayed words, the selected word is appended to the character string, and the result is then input as a character string. By repeating this process until a word indicating termination is selected, words to follow the character string are selected by the user and advertising copy is presented.

Also, the above exemplary embodiment describes a configuration in which batch training is performed in the training process. However, the configuration is not limited thereto. Online training that trains with training data and teaching data one at a time may be performed, or data to train with may be chosen from among a large amount of training data, and mini-batch training that trains with a limited set of training data may be performed

Also, a configuration is described in which the collected information DB 23A according to the exemplary embodiment stores product information and cluster information input by the user. However, the configuration is not limited thereto. For example, information may be acquired over the Internet using a Web application programming interface (API) to acquire and collect product information and cluster information. Additionally, information published on various websites may be acquired and collected over the Internet. cl EXAMPLES

Next, examples implementing an exemplary embodiment of the present disclosure will be described.

### Example 1

First, an example of implementing an exemplary embodiment of the present disclosure to present advertising copy to buyers of a product will be described.

Recently, monitor for presenting images and the like to buyers of products are being installed at point of sale (POS) cash register terminals installed in convenience stores and commercial facilities. Consequently, for example, by providing the information processing device 10 according to an exemplary embodiment of the present disclosure in a POS cash register terminal, the POS cash register terminal is capable of displaying images of recommended products together with advertising copy on a monitor when the buyer engages in a retail transaction.

For example, the POS cash register terminal uses product information acquired by reading a barcode or the like for calculating the retail transaction, and acquires information about a recommended related product. The POS cash register terminal uses product information about the recommended related product and cluster information stored in the POS cash register terminal to estimate the purchase probability (user reaction) and the confidence level for each combination of product information and cluster information, and generates advertising copy. The POS cash register terminal specifies the combination of product information and cluster information associated with the purchase probability and the confidence level exceeding predetermined threshold values from among the estimated purchase probabilities and confidence levels, and presents the advertising copy associated with the specified combination together with the image of the product on the monitor. With this arrangement, a combination of a potentially purchased product and advertising copy is specified, and advertising copy that encourages the buyer to purchase the product is presented.

In addition, product information associated with purchased products and the slogans assigned to the products may also be collected by the POS cash register terminal. Also, when a product is purchased, a card (such as a member's card, for example) storing information about the buyer and information identifying the buyer may be used to store the information about the buyer, the information identifying the buyer, product information, slogans, and the like in association with each other.

### Example 2

Next, an example of implementing an exemplary embodiment of the present disclosure for digital signage will be described. Digital signage refers to electronic advertising using a display installed in a public facility, train station, or the like. For example, by providing a display with the information processing device 10 according to an exemplary embodiment of the present disclosure and a camera, and acquiring a face image of a user looking at an advertisement, a product corresponding to the user and advertising copy associated with the product are displayed.

For example, the display acquires a face image of a user from the installed camera, and extracts information about the user, such as gender and age group, from the face image. The display acquires product information associated with a product to recommend to the user as well as stored cluster information, inputs the product information and cluster information together with the information about the user, and for each piece of cluster information, estimates the user reaction and confidence level and also generates advertising copy. The display specifies the combination of product information and cluster information associated with the user reaction and the confidence level exceeding predetermined threshold values from among the estimated user reactions and confidence levels, and presents the advertising copy associated with the specified combination of the product information and cluster information. With this arrangement, advertising copy is generated for each product advertised on the display and also for each user who looks at the advertisement, and the user is encouraged to purchase the product.

Additionally, the digital signage described above may also be installed in a shop or the like. For example, in the case where an advertising display and a camera are installed in a product section where users are present, and the information processing device 10 is provided in a server connected to the camera, images of recommended products together with advertising copy may be displayed on the display.

### Example 3

Next, an example of implementing an exemplary embodiment of the present disclosure for online advertising will be described. For example, in the case where the information processing device 10 is provided in a server, it is possible to display an online ad together with advertising copy. The server acquires information about a user viewing a site and subject information (product information) to advertise on the site. The server uses the information about the user together with the subject information and stored cluster information to estimate the click probability that the user will click on the ad (user reaction) and the confidence level, and generate advertising copy. The server specifies the combination of subject information and cluster information associated with the click probability and the confidence level exceeding predetermined threshold values from among the estimated click probabilities (user reactions) and confidence levels. The server displays the advertising copy associated with the specified combination of subject information and cluster information, together with the ad associated with the subject information. With this arrangement, advertising copy that makes the user want to click a link in the ad is presented.

Also, the example of online advertising may not only display an image together with advertising copy, but also present advertising copy in a hyperlink to an ad, news article, or the like published through the Internet. For example, in the case of wanting to cause a user to click a link or the like on a web page to guide the user to some other web page, the server provided with the information processing device 10 displays advertising copy having a high click probability as a hyperlink embedded in the web page. This arrangement makes it possible to increase the number of views for the hyperlink destination.

The above uses an exemplary embodiment to describe the present disclosure, but the present disclosure is not limited to the scope described in the exemplary embodiment.

Various modifications or alterations may be made to the foregoing exemplary embodiment within a scope that does not depart from the gist of the present disclosure, and any embodiments obtained by such modifications or alterations are also included in the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Also, the exemplary embodiment describes a configuration in which an information processing program is installed in the storage 14, but is not limited thereto. The information processing program according to the exemplary embodiment may also be provided by being recorded onto a computer-readable storage medium. For example, the information processing program according to an exemplary embodiment of the present disclosure may be provided by being recorded on an optical disc, such as a Compact Disc-Read-Only Memory (CD-ROM) or a Digital Versatile Disc-Read-Only Memory (DVD-ROM). Also, the information processing program according to an exemplary embodiment of the present disclosure may be provided by being recorded on semiconductor memory such as Universal Serial Bus (USB) memory or a memory card. Furthermore, the information processing program according to an exemplary embodiment of the present disclosure may also be acquired from an external device through a communication channel connected to the communication I/F 17.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to
acquire subject information and classification information, the subject information being information related to a subject to advertise, and the classification information being information classifying advertising copy related to the subject into a set, and
estimate a user reaction by inputting the acquired subject information and classification information into a trained reaction estimation model that estimates the user reaction.

2. The information processing device according to claim 1, wherein
the processor includes an advertising copy presentation model that presents advertising copy, and
the processor is configured to input the acquired subject information and classification information into the advertising copy presentation model to present the advertising copy corresponding to the subject information and the classification information.

3. The information processing device according to claim 2, wherein
the processor is configured to
present the advertising copy by at least one of selecting from among advertising copy created in advance, and generating advertising copy from a result learned using past subject information, past classification information expressing a set into which corresponding past advertising copy was classified, and advertising copy with respect to a past subject and a past set.

4. The information processing device according to claim 2, wherein
the processor is configured to
receive a character string as input, and input the received character string into the advertising copy presentation model, and
complement the received character string with a subsequent character string according to the advertising copy presentation model, and complete the advertising copy.

5. The information processing device according to claim 3, wherein
the processor is configured to
receive a character string as input, and input the received character string into the advertising copy presentation model, and
complement the received character string with a subsequent character string according to the advertising copy presentation model, and complete the advertising copy.

6. The information processing device according to claim 1, wherein
the classification information is information indicating a type of the set.

7. The information processing device according to claim 2, wherein
the classification information is information indicating a type of the set.

8. The information processing device according to claim 3, wherein
the classification information is information indicating a type of the set.

9. The information processing device according to claim 4, wherein
the classification information is information indicating a type of the set.

10. The information processing device according to claim 5, wherein
the classification information is information indicating a type of the set.

11. The information processing device according to claim 6, wherein
the processor is configured to
estimate the user reaction by inputting classification of a different type from past classification information used to train the reaction estimation model.

12. The information processing device according to claim 7, wherein
the processor is configured to
estimate the user reaction by inputting classification of a different type from past classification information used to train the reaction estimation model.

13. The information processing device according to claim 1, wherein
the subject information includes at least one of information that identifies a subject, descriptive text related to the subject, advertising copy about the subject, a name of the subject, information related to a component or ingredient contained in the subject, information that identifies a buyer of the subject, a time period of advertising copy related to the subject, and a target demographic at which the advertising copy is aimed.

14. The information processing device according to claim 13, wherein
the processor is configured to
acquire a plurality of information as the subject information and estimate the user reaction corresponding to the plurality of information.

15. The information processing device according to claim 1, wherein
the processor is configured to
input the acquired subject information and classification information into the reaction estimation model to additionally estimate a confidence level indicating a likelihood of the user reaction.

16. The information processing device according to claim 15, wherein
the processor is configured to
specify with priority a large user reaction among a plurality of estimated user reactions.

17. The information processing device according to claim 15, wherein
the processor is configured to
estimate a plurality of user reactions and a plurality of corresponding confidence levels according to the reaction estimation model, and
specify with priority a pair having a low confidence level from among pairs of the plurality of user reactions and the plurality of corresponding confidence levels.

18. The information processing device according to claim 16, wherein
the processor includes an advertising copy presentation model that presents advertising copy, and
the processor is configured to input the subject information associated with the specified user reaction and confidence level and the classification information into the advertising copy presentation model to present the advertising copy corresponding to the subject information and the classification information.

19. The information processing device according to claim 1, wherein
the processor is configured to
use past subject information and past classification information expressing a set into which corresponding past advertising copy was classified to train the reaction estimation model to learn a user reaction for the past subject and the past set.

20. A non-transitory computer readable medium storing a program causing a computer to execute a process for processing information, the process comprising:
acquiring subject information and classification information, the subject information being information related to a subject to advertise, and the classification information being information classifying advertising copy related to the subject into a set; and
estimating a user reaction by inputting the acquired subject information and classification information into a trained reaction estimation model that estimates the user reaction.
